(19) United States
(12) Patent Application Publication
(10) Pub. No.: US 2003/0149572 A1
(43) Pub. Date: Aug. 7, 2003

(54) Method to manage marketing and sales data of e-commerce clients

(76) Inventors: John K. Newton, Madisonville, KY (US); Willard L. Barth, Belleville, NJ (US)

Correspondence Address: Michael S. Neustel, Suite No. 4, 2534 South University Drive, Fargo, ND, 58103, US

(21) Appl. No.: 10/067,440

(22) Filed: Feb. 5, 2002

(51) Int. Cl. G06F 17/60

(52) U.S. Cl. 705/1

(57) ABSTRACT

A marketing service is provided for e-commerce sales and marketing representatives to generate a contact report and manage the flow of this information between the linked up-line and the down-line network members for the purpose of recruitment to the network service and to facilitate the sales and marketing by the service members. The service captures the Web site user experience to generate a neural dynamic profile and identify the Web browser's specific interests. This information is combined with individual browser identification to form the contact report, filed under a contact management program and passed by a teamwork communication system to the up-line team member for review of the down-line member's activity and to identify any need for collaboration on a business transaction. The information in the contact report is used to tailor a personalized response to better elicit a sale or activity from the interested party.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to the Internet marketing industry and more specifically to a method to manage the flow of business information based on the Web site user experience.

2. Description of the Prior Art

It can be appreciated that the idea of tracking customer/guest usage on a Website is not new to the Internet community. Several companies track the aggregate browser Web site activity and provide or sell that information in generic form to interested parties and vendors. These companies are interested in the user Web site experience for a number of reasons. For example, the marketing aspect of a business is concerned with the number of visitors, the length of each visit, what was viewed, what links were selected and possibly, how the Web site was navigated. From this data, the business concern may generally infer product interest and how well the architecture and mechanics of the Web site served the browsers. Armed with this group information, the business concern is able to provide a group response. The business may alter the appearance, sound, ability and/or content of the Web site such that it is ideally more appealing to generate higher activity and sales.

These prior art user tracking methods produce limited information to yield an incomplete response to market the potential client since the information gathered is not specific in nature. The particular interest of the individual browser in the product may not be directly addressed or addressed in way that may lose the sale. It is well known in the marketing industry that personal contact based on personal information yields the best results.

Also, current Web sites that do capture some personalized information may not profile the user for any effective use. For example, on-line airline/car/hotel reservation Web sites accept the user's name and billing information with a purchase. The use of this information is limited to a first name greeting the next time the user logs on and the occasional bulk e-mail concerning the latest deals. Most users view these general e-mails as a nuisance and take steps to eliminate them because they are rarely consistent with the user's specific interests. In this example, the business is not effectively using the personalized information to develop a more effective marketing method to boost sales.

What is needed is a method that captures and maximizes the marketing application of user specific information. This information would include the user identity (e-mail, name and telephone number) and a detailed analysis about the type of user and the user's specific interests that may be deduced from data captured of the user's Web site experience. This information provides the necessary elements to support an effective personalized marketing response.

Also, a method for a marketing network service is needed to apply the user specific information through an interdependent team of trained and managed goods and/or service representatives to address the user in terms the user can appreciate with information specific to the user's interest.

In these respects, the present inventive solution substantially departs from the conventional concepts, methods of the prior art, and in so doing provides a method to effectively manage the marketing and sales of goods and services based on personalized client data.

### SUMMARY OF THE INVENTION

In view of the foregoing disadvantages inherent in the known types of standard marketing services now present in the prior art, the present invention, hereafter known as the Marketing Network Service (MNS), provides a detailed marketing analysis based on the individual Web site user experience and manages that information in a pertinent and applicable manner to the appropriate network team members. This client specific information is specifically geared towards sales/marketing representatives of goods and services to facilitate a timely and effective interaction with a prospective buyer. The MNS also has the ability to admit interested parties to join as a team member through a member/up-line team member to utilize the offered services and represent their selected goods and/or services. The MNS provides the tools to manage contact data between the networked down-line team members and up-line team members to effect collaboration and support of ongoing marketing and sales activities of the junior member. The MNS also offers training to each member and provides a report of the member's training level to the up-line team member(s) to ensure effective interaction with the prospective client or potential team member.

The general purpose of the present invention, which will be described subsequently in greater detail, is to provide the e-commerce industry with a marketing and sales tool that includes many of the advantages of the standard Web site monitoring systems mentioned heretofore and many novel features that result in a new method which is not anticipated, rendered obvious, suggested, or even implied by any of the prior art standard telephone appliances, either alone or in any combination thereof.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a method that will overcome the shortcomings of the prior art devices.

An object is to provide a marketing service to capture personal client data and determine a detailed marketing analysis of the Web site user experience.

Another object is to provide a marketing service that supplies the marketing analysis of the Web site user experience and personal data to the service member and an up-line team member(s) to be used in a collaborative effort to tailor an effective interaction with the Web site user.

Another object is to provide a marketing service that provides a method for a network member to mentor and track the training of the next successive or other new and existing down-line member(s) to the service.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates a simplified diagram of the Internet environment to implement the present invention.

FIGS. 2A and 2B depict a flow chart of the steps to implement the preferred embodiment of the inventive solution.

FIGS. 3A-3D is key menu pages of the Contact Manager provided by the MNS.

FIGS. 4A-3D is the key menu pages for the Teamwork Communication System of the MNS.

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, an erasable programmable read only memory (EPROM), random access memory (RAM), magnetic and optical storage devices such as disk drives, magnetic tape, CDs (compact discs) and DVDs (digital video discs), and computer instruction signals embodied in a transmission medium (with or without a carrier wave upon which the signals are modulated).

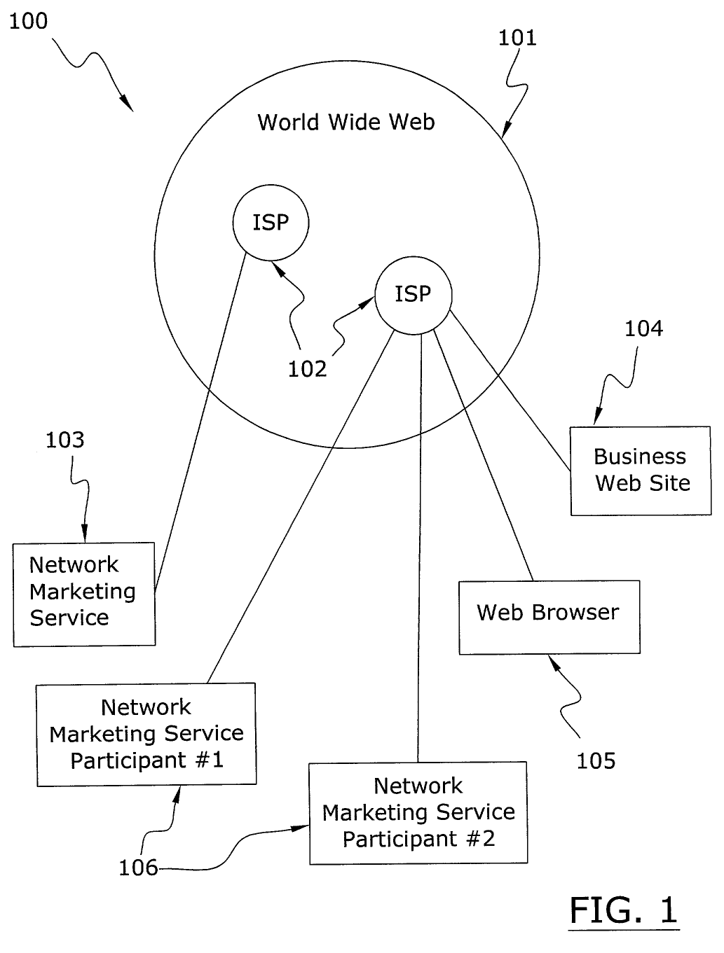

FIG. 1 illustrates a simplified diagram 100 of the Internet environment to implement the Marketing Network Service (MNS). The World Wide Web supports 101 the popular e-mail and Web site based services through Internet Service Providers (ISP) 102 between users in a manner well known in the art. The MNS 103 is presented as a Web site typically realized on a computing platform processing a proprietary program supported by a fast data handling database connected in a protected high speed manner to the Internet. The MNS could be any suitable server located in a home or business or split into several physical locations around the world. A business Web site, again usually realized on a server, is shown 104 to represent a typical Web site that presents corporate information and/or a virtual storefront to offer all manner of goods and services. The shown Web browser 105 represents the typical home system or networked business computer that provides individual Web browsing (shopping, research, e-mail etc.) access to the Internet. This browser is one of a billion potential clients or potential team members for the inventive solution. There could be any number of MNS participants, where two are shown 106 that may be located anywhere in the world using any of the commonly known methods to connect with the Internet. These participants are part of the MNS hierarchy to promote the marketing and sales of goods and services. These team members, or users, would typically be a home based concern, common to e-commerce businesses of today.

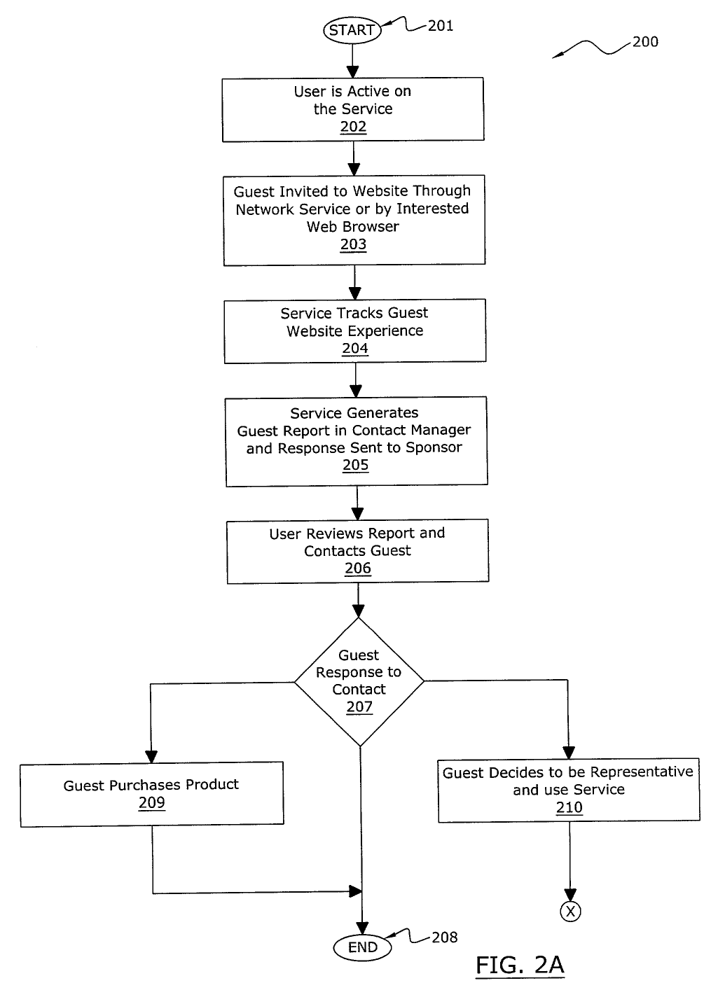

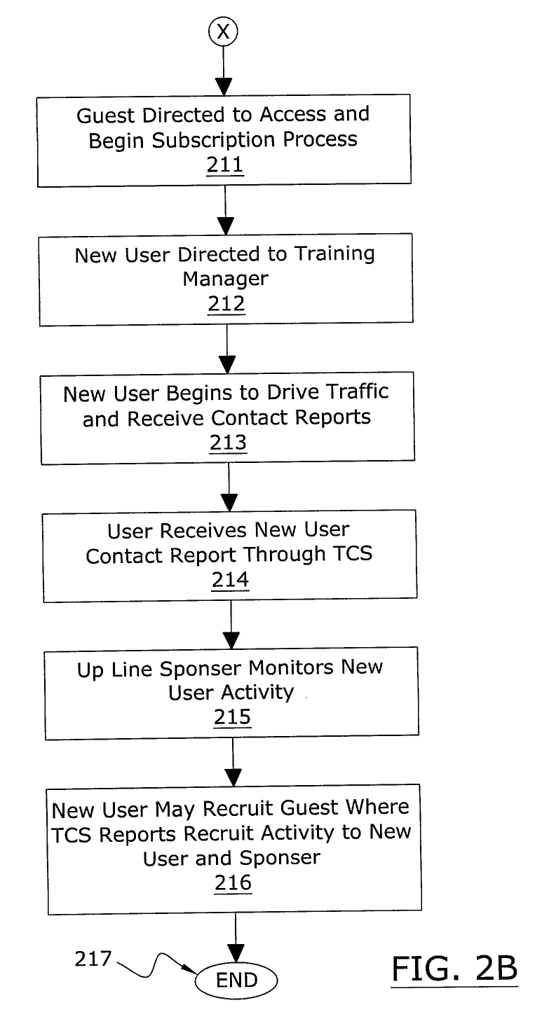

FIGS. 2A and 2B depict a flow chart 200 of the steps to implement the preferred embodiment of the marketing network service. The process begins 201 with a sales/marketing representative, hereafter known as the user, as a mid level representative active in the MNS 202. The user is linked into the network as a down-line team member just below his up-line team member, the representative that recruited him. The up-line team member is understood to be the user's up-line manager. This staffing chart may take the form of a star or a pyramid where it begins with the first member (a representative of goods and services) and branches to an expanding network of joined users in the ongoing activity of recruiting other interested users as well as the marketing and sales of their own goods and services. The MNS user of the following description could be an effective representative anywhere in the hierarchy since an active flow of marketing data is maintained between the most junior to the most senior member/representative. The user first joined MNS by logging onto the computer network Web site, selecting the join/subscription page and following the instructions on payment for subscription and setup of his own Web site on the network server. His personalized Web site becomes part of the MNS and is now ready to be used to market and promote his goods and services.

In the normal course of business, the user invites guests or accepts “walk in” business to his Web site 203. The user can bring business by manual input of the guest's information into a program file, filed under a data management algorithm termed the Contact Manager (CM), or he can upload from various personal types of computer files (electronic address books). The user can also purchase leads from the MNS to be automatically placed in the CM. This information includes the guest's names, emails and other personal or psychological information given or sold to the MNS. The Contact Manager is a powerful tool for the team member to organize and manage client data. The benefit to inviting guests in this manner is that the CM will send the guest a welcome invitation e-mail with a link to the user's site that allows the guest to visit the site without the bother to “sign” a guest book. The user can also advertise his Web site in any effective method to attract the browser. These methods may include newspapers, search engines, flyers, mailings or bulletin board postings. Upon arrival to the Web site by the random browser, the guest is prompted to sign a guest book so the guest's personal information can be attached to the record that is created on them. This personal information needs to include the guest's name and e-mail address but preferably also contains a correspondences address and telephone number.

Next, the guest tours or experiences the site commensurate with the guest's interest in the content. The MNS tracks the experience or viewing activity 204 for subsequent processing to aid the representative in his follow up efforts. What the guest viewed, how long on any particular page or audio presentation, links selected, questions answered and total time in the Web site are a few of the browser activities that are detected and recorded to comprise the user experience.

The MNS detects guest departure and performs several functions 205. First, the MNS attaches the monitored data to the personal data and deposits the information in the guest file under the CM. The MNS determines a neuro dynamic profile and identifies the Web site content the browser showed degrees of interest based on the captured guest experience. This information is also added to the guest file. A contact report is generated of the guest file and may be immediately e-mailed to the user. The user may also be notified of all or any particular guest visit by other methods such as instant message, page or telephone call. The contact report may include, but is not limited to, the pages and page sections of the Web site that the guest visited and how long the guest was on each page. This information is important because many of the pages are multi-media and have a designated viewing length for completion. If the guest stayed on that section for the allotted viewing time, the user can deduce that the guest viewed the whole multi-media presentation. Also, a summary of the user experience with the neuro dynamic profile is provided.

The neuro dynamic profile (NDP) is an analysis of the personality type, communication style, motivation strategy, decision strategy and other psychological profiled information developed from the data captured during Web site user experience. Basic personality types that can be determined include aggressiveness, patience, intelligence and practicality. A communication style is based on whether the guest shows a predilection to information presented in a visual, auditory, kinetic or analog/digital fashion. A motivation strategy can be deduced from the guest's tendency to move away from pain or to move toward pleasure. A decision strategy is evidenced through the guest's tendency to collect and base a decision based on information from others or internalize the information for self-determination.

In the next step, the user receives notification 206 of the guest contact and reviews the report. The user can read the e-mail report and/or access his CM and review a detailed report on the guest information. The user could also have the guest receive auto-responder e-mails that are sent out automatically when the guest concludes the Web site visit. Use and content of the auto-responder e-mail are determined by the user based on the report results of the guest visit. These auto-responder emails are neuro dynamically enhanced using the psychological profile established during the tracking procedure. The wording, content, layout, graphics of this follow up email are tailored to the particular profile of the contact. In this way, the follow up response can be tailored to the personality and individual interests of the guest. Guest contact could be provided through whatever means is appropriate and available to investigate the guest's interest in the Web site content. “Next Visit” issues are also addressed. When a contact returns to the site and signs the guest book, the MNS automatically detects who it is, that they have been here before, analyzes the neuro dynamic profile and tailors the content and user experience to best match his/her neuro dynamic profile (his or her buying and decision making strategy) to better elicit a sale or action from them.

At this point in time, the guest will generally elect 207 to ignore user contact 208 or, in an e-commerce scenario, the user would respond to the contact and pursue his interest in or purchase 209 the user's goods and services. Also, in a participatory scenario, the guest could indicate a real interest in the product and request to become a representative 210 under the MNS. The user responds to the user request by directing the guest to access the user's Web site and begin the subscription process. In the happy event the guest is also interested in purchasing a product; the user can direct the recruit to become his own first customer. In the subscription process, the guest is now “down-line” linked to the user as being referred or recruited by the user to the system and thus “attached” to user in the MNS. With respect to the new relationship of the guest and user, the guest becomes the new member or down-line member and the user is termed the up-line team member.

With completion of the subscription process, the new member is directed 212 to the Training Manager (TM), an information program governed by the MNS. These steps are carried out on the new member's own Internet linked (home) computer system. The Training Manager is a training system setup where the new user can be trained on-line through multi-media presentations, audio recordings and text material on how to benefit and use the user's (his up-line team member) goods and services and how to use the MNS itself. A report is generated, similar to the guest information report, each time the new member accesses the Training Manager. His training level status is monitored by the up-line team member(s). In this way, the up-line team member(s) is enabled to guide and monitor the new member's training progress so that the new member can be fully trained by the up-line member(s) and MNS. The reporting is handled through the MNS Teamwork Communication System (TCS) program.

After sufficient training, the new member begins 213 to drive guest traffic to his Web site in the same way as his up-line team member where these Web sites are maintained on the NIS computing platform. The new member receives a contact report with guest information in a manner similar to the up-line team member but the up-line team member(s)' TCS is updated with the new user's contact and guest information 214. This reporting method allows the up-line team member(s) to monitor the new user's activity and enable the up-line team member(s) to collaborate with an inexperienced or disadvantaged new user on the guest information and follow up together, perhaps a three way telephone call, with the interested guest 215. If the guest elects to also join the Marketing Network Service, become a representative under the MNS, then the process previously described to create the up-line team member and new member team repeats 216 where the (old) new member becomes an up-line team member to the next member and the up-line team member is now a up-line team member to both the new and next down line members 217. In this way, a collaborating team is formed within the service network.

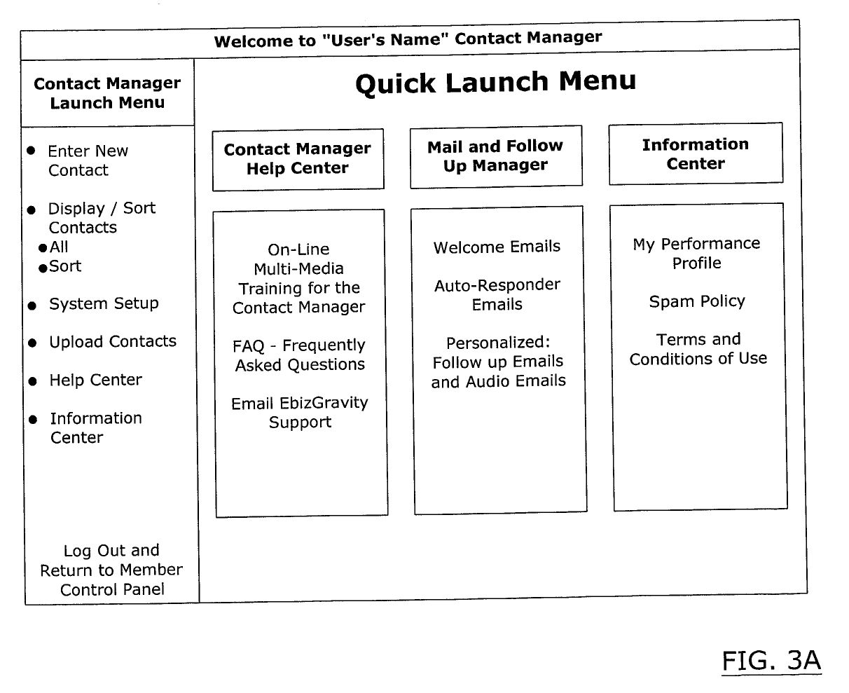

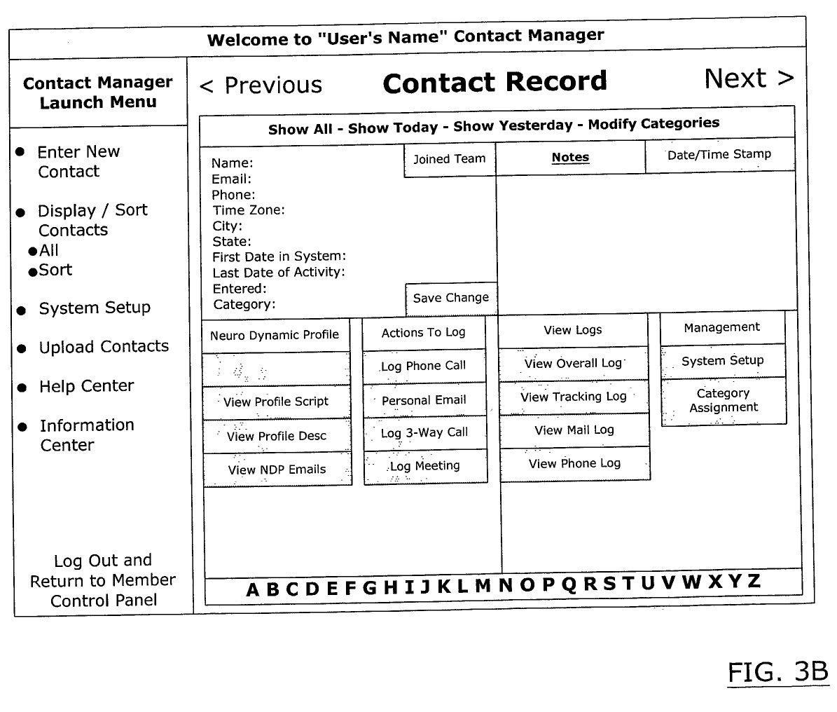

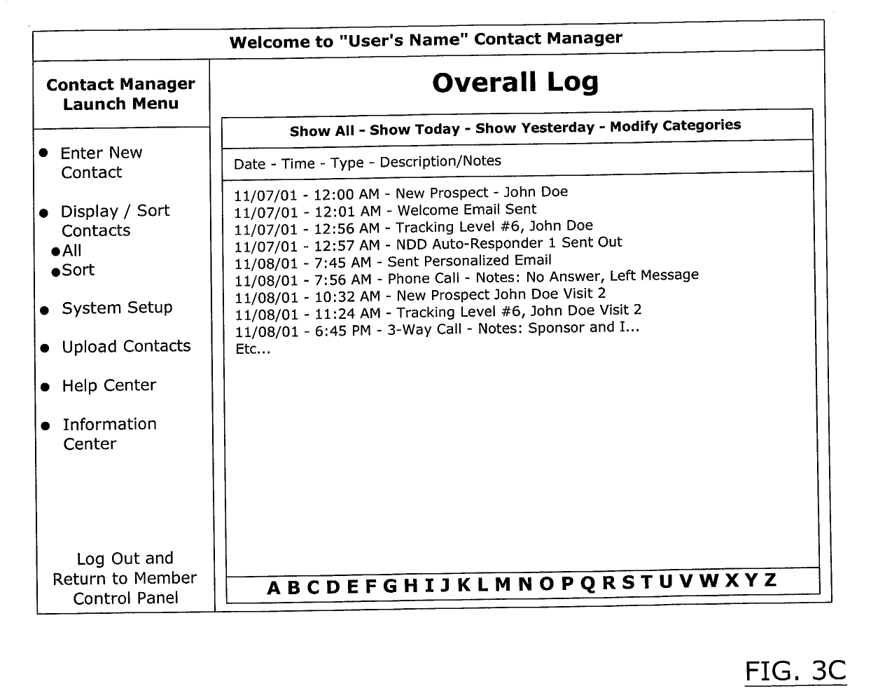

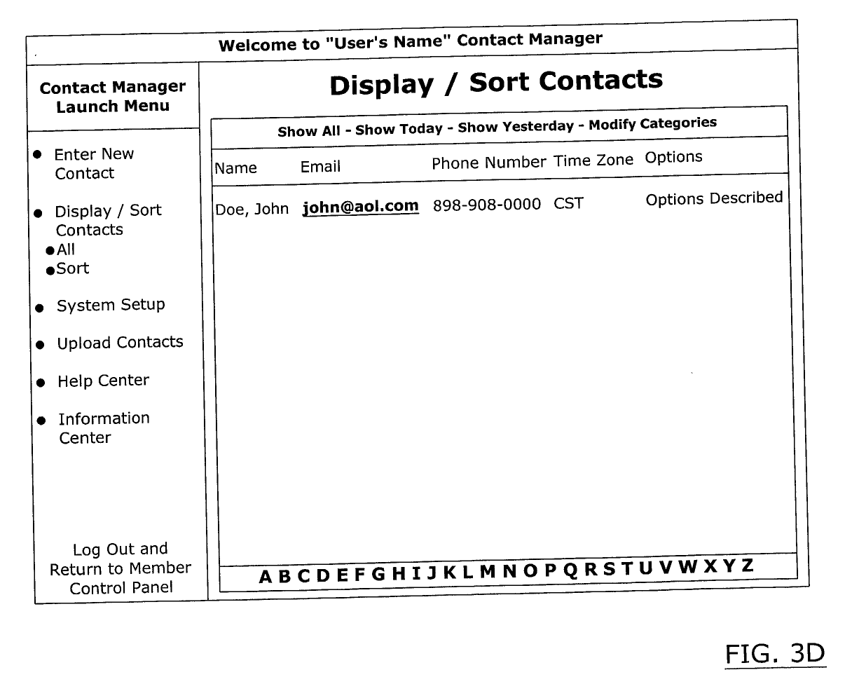

FIGS. 3A-3D show a representation of the main menu pages to provide the team member navigation within the Contact Manager (CM), a key program tool for a participant in the MNS. The CM is accessed through a “link” in the member control panel of the MNS main program menu. The CM records the time of use by the individual team member for evaluation by a senior team member(s) in the network. This information is reported through the Teamwork Communication System. FIG. 3A depicts the first page of the CM. The top frame is a welcome message and identifies that the CM has been accessed. The initial main frame contains the quick launch to the help center, mail manager and information center. The left frame is the launch menu and remains available throughout the CM.

FIG. 3B shows the Contact Record page to accept the data for a new contact or to modify an old account. Explanation of several key entries includes:

Last Date of Activity is the last data of prospect/contact activity, not the team member.

First Date in System is when the client was entered or last appended. The CM checks, with client information entry on the participants Web site, to see if there is a record with that e-mail address. If none is found, the service adds the name, e-mail and telephone and starts a new record and appends the Pro New Prospect and then subsequently, the tracking to the log (Pro New Prospect is a rating system of the contact).

Category is the user defined category from the category assignment button. It is default and mandatory category 1.

Joined Team button puts in the contact log that the client joined MNS and switches category to team member.

View Profile Script opens a window with the appropriate script for the key code that is in the Neuro Dynamic Profile Box.

View Profile Description will bring up a window with the prospects description of their particular Neuro Dynamic Profile (NDP).

View NDP E-mails will bring up a screen that shows the several NDE e-mails that will be sent out over the next several days, months or years.

Log Phone Call, Log 3-Way and Log Meeting open a corresponding page to manually insert notes or comments.

View Overall Log shows all entries in the log whether track information, telephone, meeting, e-mail, 3-way or Pro New Prospect. FIG. 3C is an example of the sub menu for the Overall Log. The other view logs show just their particular category.

System Setup allows access to customize the system default and how it can operate for just this prospect. There will be global settings and individual contact settings.

Category Assignment is to assign what category this prospect falls into. The default is the category 1 list.

FIG. 3D is an example of the Display/Sort Contacts menu page. It provides a configurable way to display a list or group of contacts. In addition to the typical column for the prospect name, e-mail, telephone, and time zone, an option column provides access to any contact information, category assignment, mail preferences or a remove function. The user can click on the name or contact information to link to a detail screen on the contact.

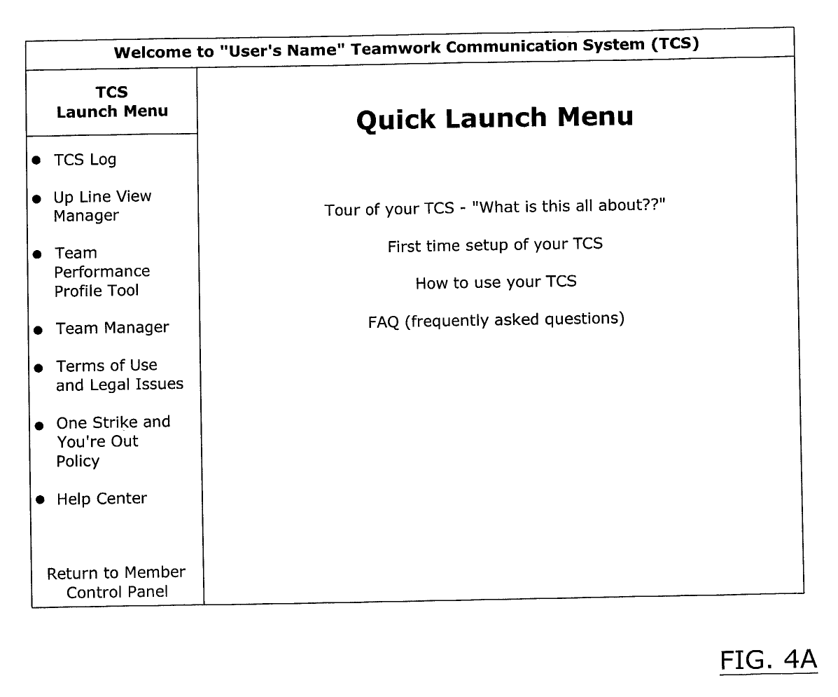

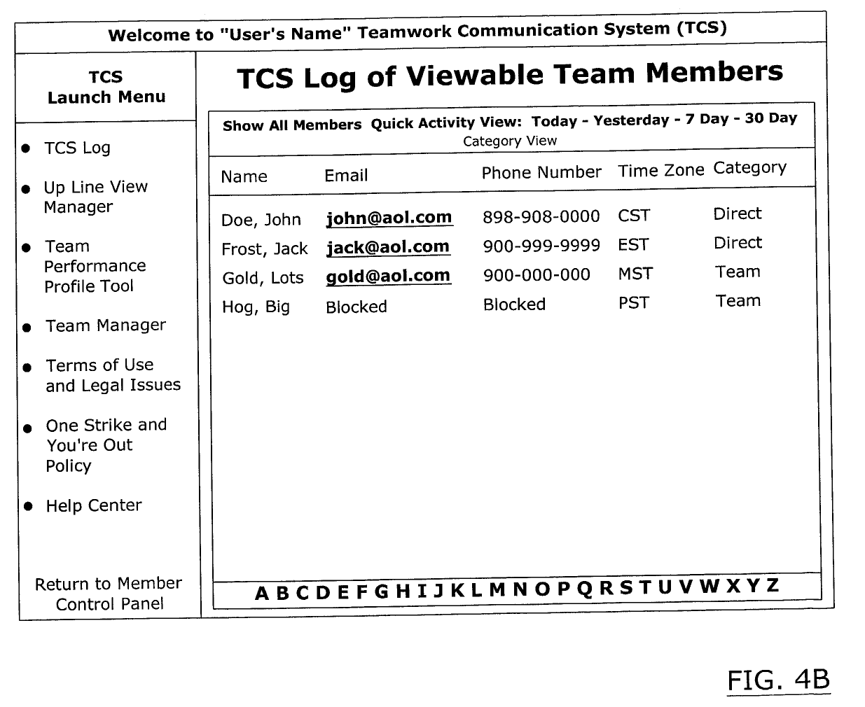

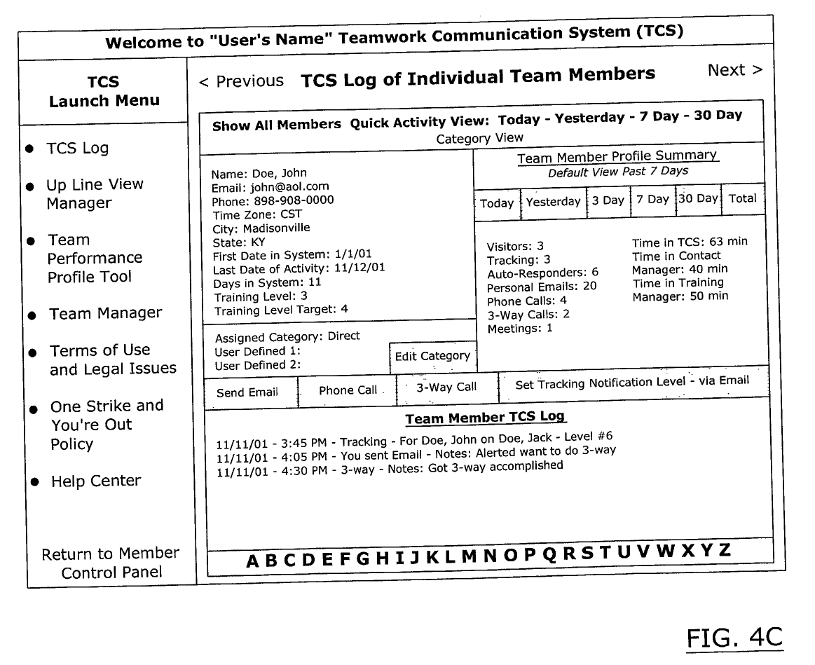

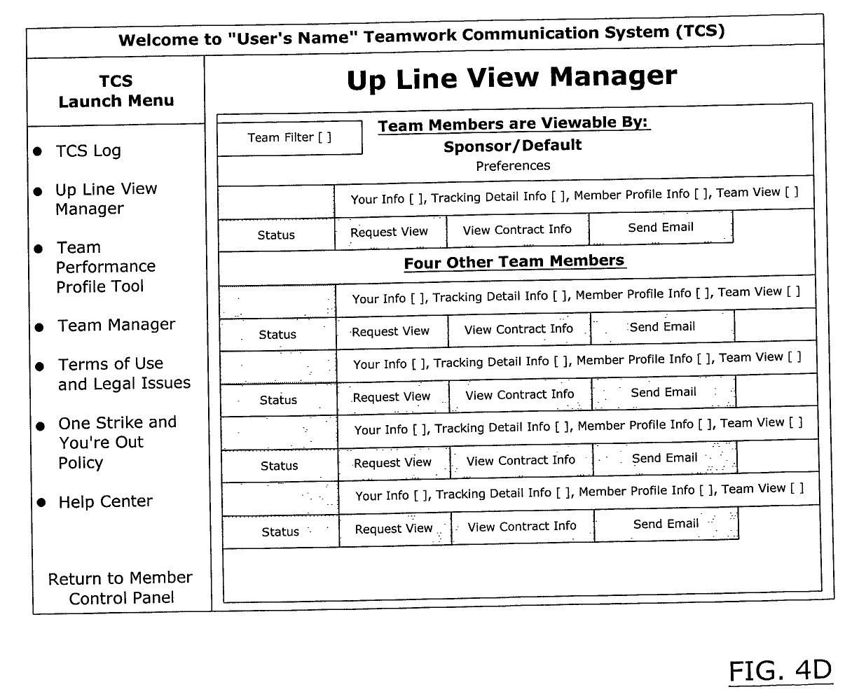

FIGS. 4A-4D show a representation of the main menu pages to navigate the Teamwork Communication System (TCS), where TCS is a powerful management tool for the team member. The TCS is accessed through a “link” in the Member Control Panel. TCS tracks and manages guest information and member activity information between all successively recruited down line members of the MNS. The individual TCS user is enabled to limit the information viewable to the up-line team member(s). The MNS also tracks the time of use by the team member for evaluation by the appropriate up-line team member(s).

FIG. 4A represents the first page of the TCS. The top frame is the welcome message and indication to confirm access to the TCS. The initial main frame contains the quick launch to setup and help areas and the left frame is a launch menu that remains available throughout the TCS.

FIG. 4B is a representation of the TCS Log of down-line viewable members. The listing is first sorted by Category then by an alphabetical sort of all the TCS members that are viewable. A button click on a name reveals an individual record. The Quick Activity View button provides access to view members who have had activity today, yesterday, past 7 days or the past 30 days. Activity is anyone who has received a tracking report or other activity within that time.

FIG. 4C is an example of a TCS individual log. An explanation of the key sections of the menu is described as follows:

Team Member TCS Log can display a team member's overall log if authorized (viewable) by the down line team member or, if not authorized, a display of tracking notices and the user's notes or entries.

Name, E-mail etc. is not editable since it is provided from the team member's record.

Last Date of Activity is activity from the team member's tracking reports.

Category is set by the user and the team member in the setup process.

Training Level is the expected level of training by the team member.

Training Level Target is a time line to correlate the expected training level with the number of days in the service.

Team Member Profile Summary shows the information based on the view button selected.

Set Tracking Notification Level via E-mail is a selectable user set point of the tracking level (1-6) depending on time spent on the site. 1 being 10 minutes or more all the way to 6 being 60 minutes or more. The purpose is to trigger receipt of a notification e-mail. The tracking log will be displayed in the Team Member TCS Log and sent in the form of notifications in two formats:

Open-meaning the TCS user can see all the detail of their team members tracking report; and,

Blocked-meaning the TCS user can see only the tracking subject line but when viewing the body of the e-mail the contact information of the prospect is not available.

Edit Category brings up a screen with a dropped down list to allow the user to manage categories as available in the Contact Manager.

FIG. 4D is a representation of a TCS menu page for the user to manage what the up-line manager(s) can view. The first blank is to input the up-line team member identification (ID code) of the up-line team member. The following preferences are set by the TCS user:

Your Info (drop down list):

Open-information if full viewable to up line managers

Limited-personal information is viewable but logs are blocked except the tracking log

Blocked-personal information, except for name, is blocked, tracking reports are viewable

Tracking Detail Info:

Open-tracking report contact information is viewable

Blocked-the tracking report contact information is not viewable

Member Profile Info:

Open-complete profile is viewable

Limited-all but the time is viewable

Blocked-profile is completely blocked

Team View:

Open-complete team is viewable to this person, based on their team view filter

Limited-team is viewable only by name and stats, no contact

Blocked-nothing is viewable

Team Filter:

Open-allow anyone in up line who makes team viewable to view user in full

Limited-no contact info on TCS user or prospects (cannot contact user or prospects)

Blocked-TCS user not viewable

Status-request sent or confirmed

View Contact Info reveals a simple screen with name, e-mail, phone current in service

Send E-Mail opens an e-mail screen

It is a second embodiment of the invention to provide the features of the Marketing Network service to reside with the potential client and “follow” the client to any Web site that the client visits on the Wide World Web.

It is a third embodiment of the invention to provide the features of the Marketing Network Service to expand computing platforms other than the Internet to manage sales/marketing contact data.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A method for a marketing service to generate and manage sales and marketing information for service members comprising:
(a) obtaining personal information of a guest;
(b) tracking the viewing activity of the guest considering an offer for goods and/or services;
(c) creating a neuro dynamic profile particular to each guest;
(d) combining the personal information, viewing activity and neuro dynamic profile to form a contact report;
(e) storing the contact report under a contact management program file;
(f) moving the contact information between service members; and
(g) using the contact information by the service members.

2. A method as claimed in claim 1 where said neuro dynamic profile is characterized by personality type, communication style, motivation strategy and decision strategy.

3. A method as claimed in claim 1 where said storing comprises storing said viewing activity and said neuro dynamic profile as a guest file under the Contact Manager governed by the marketing service.

4. A method as claimed in claim 1 where said moving the information comprises data management provided by the Teamwork Communication System governed by the marketing service.

5. A method as claimed in claim 1 where said using the information by the service members comprises evaluation of the contact report by the team members to form a guest response that is psychologically effective to encourage guest activity or sales.

6. A method for a marketing network service to generate and manage sales and marketing information for service members comprising:
(a) subscribing to a marketing network service to be a new member communicatively linked to the recruiting up-line team member(s);
(b) training the new member through the marketing service where the training progress is tracked by the up-line team member(s);
(c) bringing business to a Web site presenting goods and/or services on the marketing network service computing platform;
(d) obtaining the Web site browser personal information;
(e) capturing the Web site user experience;
(f) detecting the departure of the Web site user from the Web site;
(g) generating a contact report;
(h) notifying the new member of a business contact by receiving a contact report;
(i) accessing a data managing program to retrieve or input data;
(j) monitoring the contact report and activity of the new member; and
(k) using the information by the service members.

7. A method as claimed in claim 6 where said bringing business comprises inviting traffic based on purchased leads given or sold to said marketing network service and inviting traffic through promotion of the Web site through, newspapers, flyers, Web advertisements and Web links.

8. A method as claimed in claim 6 where said obtaining comprises the Web site browser signing a guest book with personal information.

9. A method as claimed in claim 8 where said personal information comprises the Web site user's name, e-mail address, correspondence address and telephone number.

10. A method as claimed in claim 6 where said Web site user experience comprises the length of time the user visited the site, what site pages were viewed and the length of time each page was viewed.

11. A method as claimed in claim 6 where said generating a contact report comprises a neuro dynamic profile and identified interests of the Web site user.

12. A method as claimed in claim 11 where said neuro dynamic profile and said interests are derived from said personal information and said Web site user experience.

13. A method as claimed in claim 11 where said neuro dynamic profile is characterized by personality type, communication style, motivation strategy and decision strategy.

14. A method as claimed in claim 6 where said notifying is characterized by communication through e-mail, posted mail and telephone.

15. A method as claimed in claim 6 where said monitoring further comprises monitoring by the up-line team member(s) to determine the activity status of the down-line member, motivate the down-line member and to determine to collaborate with the down-line member regarding a contact report.

16. A method as claimed in claim 6 where said using the information by the service members comprises evaluation of the contact report by the team members to form a guest response that is psychologically effective to encourage sales.

17. A method as claimed in claim 6 where said using further comprises providing information to the Web site user, transacting a sale of goods and/or services with the Web site user and accepting subscription of the Web site user to the marketing network service.

18. A method as claimed in claim 6 where said communicatively linked and said monitoring and said tracked comprises a flow of business information between the down-line member and the appropriate up-line team member(s) is facilitated by the Teamwork Communication System.

19. A method as claimed in claim 6 where said data management program is the Contact Manager program governed by the marketing network service.
